(19) United States
(12) Patent Application Publication
(10) Pub. No.: US 2012/0176339 A1
(43) Pub. Date: Jul. 12, 2012

(54) SYSTEM AND METHOD FOR GENERATING CLICK INPUT SIGNAL FOR OPTICAL FINGER NAVIGATION

(75) Inventors: HAO-CHUN CHEN, Tu-Cheng (TW); YAO-TING WU, Tu-Cheng (TW); DHIH-YUE WANG, Tu-Cheng (TW)

(73) Assignee: HON HAI PRECISION INDUSTRY CO., LTD., Tu-Cheng (TW)

(21) Appl. No.: 13/194,996

(22) Filed: Jul. 31, 2011

(30) Foreign Application Priority Data
Jan. 7, 2011 (TW) 100100559

(51) Int. Cl. G06F 3/042

(52) U.S. Cl. 345/175

(57) ABSTRACT

A system for generating click input signal for optical finger navigation, includes a touch sensor, a timing unit, and a control unit. The touch sensor is adapted to sense whether a finger presses thereon. The timing unit is adapted to time a duration time of the finger pressing on the touch sensor when the finger presses on the touch sensor. The control unit is adapted to generate a first click signal when the duration time is greater than a threshold value and generate a second click signal when the duration time is smaller than a threshold value.

### BACKGROUND

1. Technical Field

The present disclosure relates to a system and method for generating click input signal for an optical finger navigation.

2. Description of Related Art

With the ever-increasing popularity of portable electronic devices, demands for small and low cost pointing device have increased dramatically. For example, optical finger navigation technologies are used widely to control cursor on a screen of an electronic device. Usually, optical finger navigation apparatus senses the motions of a finger by tracking the changes in the captured images from the reflection of the navigation surface on which the finger moves. However, conventional optical finger navigation apparatus often cannot provide click inputs, such as the mouse left button click input or the mouse right click input.

Therefore, there is room for improvement within the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of an exemplary embodiment of a system for generating click input signal for optical finger navigation.

FIG. 2 is a flow diagram of an exemplary embodiment of a method for generating click input signal for optical finger navigation.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

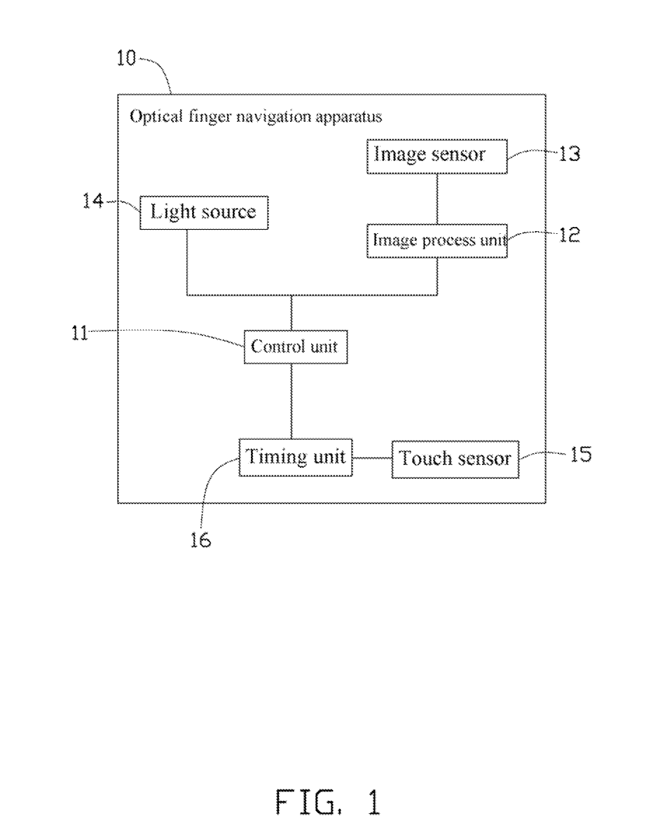

Referring to FIG. 1, a system for generating click input signal for optical finger navigation in accordance with an exemplary embodiment includes an optical finger navigation apparatus 10. The optical finger navigation apparatus 10 includes a control unit 11, an image process unit 12, an image sensor 13, a light source 14, a touch sensor 15, and a timing unit 16.

The control unit 11 is connected to the light source 14. The light source 14 dissipates light on a finger of a user. The image sensor 13 senses the image of the finger in a unique frequency. The image process unit 12 is connected to the image sensor 13. The image process unit 12 processes images sensed by the image sensor 13 to get a finger motion signal which represents the motion direction and distance of the finger. The control unit 11 is connected to the image process unit 12 and receives the finger motion signal. The control unit 11 controls a cursor moving on a screen according to the finger motion signal.

The timing unit 16 is connected to the touch sensor 15. In one embodiment, the touch sensor 15 is a touch screen. When the finger presses on the touch sensor 15, the touch sensor 15 is triggered to generate a corresponding touch signal. The touch signal is transmitted to the timing unit 16. When the finger moves away from the touch sensor 15, the touch signal is disappeared. The timing unit 16 times a duration time of the touch signal. The control unit 11 is connected to the timing unit 16 and receives the duration time of the touch signal. The control unit 11 compares the duration time with a threshold value. When the duration time is greater than the threshold value, the control unit 11 generates a first click signal, such as mouse left button click signal. When the duration time is smaller than the threshold value, the control unit 11 generates a second click signal, such as mouse right button click signal.

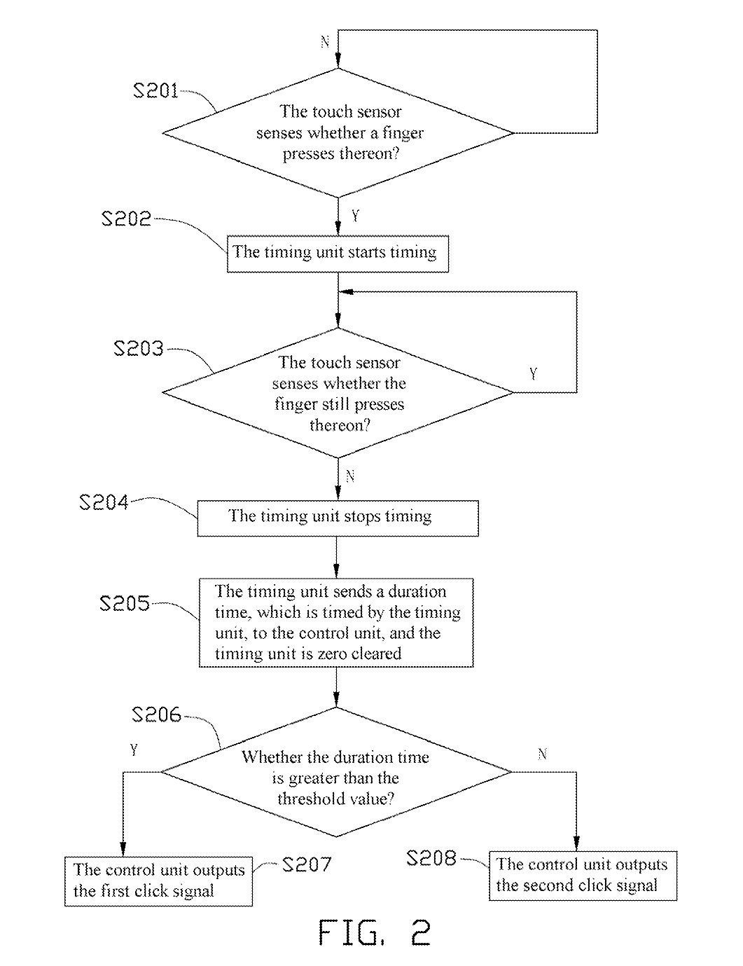

Referring to FIG. 2, a method for generating click input signal for optical finger navigation includes following steps.

In step S201, the touch sensor 15 senses whether a finger presses thereon; if there is a finger pressed thereon, go to step S202, and if not, stay in step S201.

In step S202, the timing unit 16 starts timing, then go to step S203.

In step S203, the touch sensor 15 senses whether the finger is still pressing thereon; if the finger no longer presses thereon, go to step S204; and if the finger still presses thereon, stay in step S203.

In step S204, the timing unit 16 stops timing, then go to S205.

In step S205, the timing unit 16 sends a duration time, which is timed by the timing unit 16, to the control unit 11; then the timing unit 16 resets the duration time value to zero.

In step S206, the control unit 11 compares the duration time with the threshold value to check if the duration time is greater than the threshold value, if it is, go to step S207, and if it is not, go to step S208.

In step S207, the control unit 11 outputs the first click signal.

In step S208, the control unit 11 outputs the second click signal.

It is to be understood, however, that even though numerous characteristics and advantages of the embodiments have been set forth in the foregoing description, together with details of the structure and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A system for generating click input signal for optical finger navigation, comprising:
a touch sensor adapted to sense whether a finger presses thereon;
a timing unit adapted to time a duration time of the finger pressing on the touch sensor when the finger presses on the touch sensor; and
a control unit adapted to generate a first click signal when the duration time is greater than a threshold value and generate a second click signal when the duration time is smaller than a threshold value.

2. The system of claim 1, further comprising a light source connected to the control unit, wherein the light source is adapted to dissipate light on the finger.

3. The system of claim 2, further comprising an image sensor, wherein the image sensor is adapted to sense image of the finger in a unique frequency.

4. The system of claim 3, further comprising an image process unit, wherein the image process unit is adapted to process images sensed by the image sensor to get a finger motion signal.

5. The system of claim 4, wherein the finger motion signal represents motion direction and distance of the finger, and the control unit is adapted to control a cursor moving on a screen according to the finger motion signal.

6. The system of claim 1, wherein the first click signal is a mouse left button click signal, and the second click signal is a mouse right button click signal.

7. A method for generating click input signal for optical finger navigation, comprising:
setting a threshold value;
sensing whether a finger presses on a touch sensor;
timing a duration time of the finger pressing on the touch sensor when the finger presses on the touch sensor;
outputting a first click signal when the duration time is greater than the threshold value, and outputting a second click signal when the duration time is smaller than the threshold value.

8. The method of claim 7, wherein the first click signal is a mouse left button click signal, and the second click signal is a mouse right button click signal.

9. A method for generating click input signal for optical finger navigation, comprising:
providing a touch sensor, a timing unit, and a control unit;
sensing whether a finger presses on the touch sensor;
timing a duration time of the finger pressing on the touch sensor by the timing unit when the finger presses on the touch sensor; and
generating a first click signal by the control unit when the duration time is greater than a threshold value, and generating a second click signal by the control unit when the duration time is smaller than the threshold value.

10. The method of claim 9, wherein after sensing the finger to press on the touch sensor, the timing unit starts timing.

11. The method of claim 10, wherein after sensing the finger not to press on the touch sensor, the timing unit stops timing, and then the duration time is sent to the control unit, and the timing unit is zero cleared.

12. The method of claim 9, wherein the first click signal is a mouse left button click signal, and the second click signal is a mouse right button click signal.
